(19) United States
(12) Patent Application Publication
(10) Pub. No.: US 2025/0111777 A1
(43) Pub. Date: Apr. 3, 2025

(54) REMOTE MONITORING DEVICE, REMOTE MONITORING METHOD, NON-TRANSITORY COMPUTER READABLE RECORDING MEDIUM STORING REMOTE MONITORING PROGRAM, REMOTE MONITORING SYSTEM, AND DEVICE

(71) Applicant: Panasonic Intellectual Property Corporation of America, Torrance, CA (US)

(72) Inventors: Hiroki FURUKAWA, Osaka (JP); Kohhei HAYASHIDA, Kyoto (JP)

(21) Appl. No.: 18/977,024

(22) Filed: Dec. 11, 2024

Related U.S. Application Data
(63) Continuation of application No. PCT/JP2023/018019, filed on May 12, 2023.

(30) Foreign Application Priority Data
Jun. 15, 2022 (JP) 2022-096315

(51) Int. Cl. G08G 1/0965; B60W 30/18

(52) U.S. Cl. CPC G08G 1/0965; B60W 30/18009; B60W 2420/403; B60W 2420/54; B60W 2554/4041

(57) ABSTRACT

A remote monitoring device includes: an acquisition part that acquires a plurality of pieces of positional information indicative of respective positions of a plurality of vehicles and a plurality of pieces of sound data indicative of sounds in respective surroundings of the vehicles; a detection part that performs detection of a siren sound of an emergency vehicle in each of the acquired pieces of sound data; an estimation part that estimates a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle.

### FIELD OF INVENTION

The present disclosure relates to a technique for remotely monitoring a plurality of vehicles configured to travel autonomously and travel under remote control.

### BACKGROUND ART

For example, a monitoring device of Patent Literature 1 includes: an acquisition part that acquires a plurality of pieces of sound information detected in movers configured to be remotely supervised by a supervisor and move via autonomous driving; and a notification part that notifies the supervisor of target sound information, i.e., one of the pieces of sound information acquired by the acquisition part that meets a predetermined criterion for requiring a confirmation of a moving state. The acquisition part acquires a plurality of pieces of image information and the pieces of sound information that are detected in the movers configured to be remotely supervised by the supervisor and move via autonomous driving. The notification part causes the monitoring device to display thereon the pieces of image information in a display state which notably shows an association between the target sound information, i.e., one of the pieces of sound information acquired by the acquisition part that meets the predetermined criterion, and one of the pieces of image information that is associated with the target sound information.

However, the conventional technique described above hardly makes it possible to carry out a prompt and proper remote control of a vehicle approached by an emergency vehicle. Therefore, a further improvement has been demanded.
Patent Literature 1: Japanese Patent No. 6971069

### SUMMARY OF THE INVENTION

The present disclosure has been worked out in order to solve the problem described above, and an object thereof is to provide a technique which makes it possible to carry out a prompt and proper remote control of a vehicle approached by an emergency vehicle.

A remote monitoring device according to the present disclosure is a remote monitoring device for remotely monitoring a plurality of vehicles configured to travel autonomously and travel under remote control, and includes: an acquisition part that acquires a plurality of pieces of positional information indicative of respective positions of the vehicles and a plurality of pieces of sound data indicative of sounds in respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

The present disclosure makes it possible to carry out a prompt and proper remote control of a vehicle approached by an emergency vehicle.

### BRIEF DESCRIPTION OF THE DRAWINGS

FIG. 1 is a diagram showing a general configuration of a remote monitoring system according to an embodiment of the present disclosure.

FIG. 2 is a diagram showing a configuration of a remote monitoring device according to the embodiment of the present disclosure.

FIG. 3 is a block diagram showing a specific configuration of a detection part of the embodiment of the present disclosure.

FIG. 4 is a graph representing exemplary sound waveform and frequency spectrogram of a siren sound of an ambulance.

FIG. 5 is a graph representing exemplary sound waveform and frequency spectrogram of a siren sound of a police car.

FIG. 6 is a block diagram showing a specific configuration of an estimation part of the embodiment of the present disclosure.

FIG. 7 is a schematic illustration of a process of estimating a position of an emergency vehicle.

FIG. 8 is a block diagram showing a specific configuration of an estimation part of a modification of the present disclosure.

FIG. 9 is a block diagram showing a specific configuration of an identification part of the embodiment of the present disclosure.

FIG. 10 is a flowchart illustrating operations of a remote monitoring process in the remote monitoring device of the embodiment of the present disclosure.

FIG. 11 is an illustration showing exemplary display screens displayed on a display part in an ordinary mode in which no emergency vehicle is approaching.

FIG. 12 is an illustration showing exemplary display screens displayed on the display part in an emergency vehicle approach mode in which an emergency vehicle is approaching.

FIG. 13 is an illustration showing another exemplary display screens displayed on the display part in the ordinary mode in which no emergency vehicle is approaching.

FIG. 14 is an illustration showing another exemplary display screens displayed on the display part in the emergency vehicle approach mode in which an emergency vehicle is approaching.

### DETAILED DESCRIPTION

### Knowledge Underlying the Present Disclosure

Patent Literature 1 discloses notifying the supervisor of the target sound information, i.e., one of the pieces of sound information detected in the movers that meets the predetermined criterion for requiring the confirmation of a moving state. However, the monitoring device of Patent Literature 1 fails to detect a positional relationship between the remotely monitored movers and the emergency vehicle, failing thus to detect at what distance and which mover is approached by the emergency vehicle among the movers. Consequently, there has been a problem that, in a case where a mover is approached by an emergency vehicle, the mover could be hardly moved over properly via a remote control so as to avoid that the mover obstruct the passage of the emergency vehicle.

The following technique will be disclosed in order to solve the problem described above.

(1) A remote monitoring device according to an aspect of the present disclosure is a remote monitoring device for remotely monitoring a plurality of vehicles configured to travel autonomously and travel under remote control, and includes: an acquisition part that acquires a plurality of pieces of positional information indicative of respective positions of the vehicles and a plurality of pieces of sound data indicative of sounds in respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

In this configuration, a vehicle approached by the emergency vehicle is identified among the vehicles, and the vehicle approached by the emergency vehicle is indicated. This makes it possible to carry out a prompt and proper remote control of the vehicle approached by the emergency vehicle.

(2) The remote monitoring device disclosed in the above-mentioned (1) may further include: a frequency domain transform part that transforms the pieces of sound data in a time domain into a plurality of pieces of sound data in a frequency domain, wherein the detection part may include a peak frequency detection section that detects a peak frequency in a frequency spectrum of each of the pieces of sound data in the frequency domain, an emergency vehicle frequency pattern storage section that stores in advance a frequency pattern having a peak frequency of each of a plurality of siren sounds varying according to types of emergency vehicles, and a determination section that compares respective frequency patterns having the detected peak frequencies with each of the frequency patterns stored in the emergency vehicle frequency pattern storage section and determines, in a case where a frequency pattern having a detected peak frequency matches one of the frequency patterns stored in the emergency vehicle frequency pattern storage section, that a piece of sound data having the detected peak frequency includes the siren sound.

In this configuration, in the case where a frequency pattern having the peak frequency detected in the sound data matches one of the frequency patterns stored in advance in the emergency vehicle frequency pattern storage section, the sound data is determined to include the siren sound. This makes it possible to easily perform the detection as to whether the sound data includes the siren sound.

(3) The remote monitoring device disclosed in the above-mentioned (1) or (2) may further include: a frequency domain transform part that transforms the pieces of sound data in a time domain into a plurality of pieces of sound data in a frequency domain, wherein the estimation part may include a peak frequency level detection section that detects a level of a peak frequency in a frequency spectrum of each of the pieces of sound data in the frequency domain, and a position estimation section that estimates the position of the emergency vehicle using the respective pieces of positional information of the vehicles, a result of the detection of the siren sound in each of the pieces of sound data, and the respective levels of the peak frequencies detected in the pieces of sound data.

Distances from a plurality of vehicles to an emergency vehicle and loudnesses of pieces of sound including a siren sound collected by the vehicles are correlated to each other. Therefore, the position of the emergency vehicle can be estimated using pieces of positional information of vehicles, results of detection of the siren sound in the pieces of sound data, and levels of peak frequencies detected in the pieces of sound data.

(4) The remote monitoring device disclosed in the above-mentioned (1) or (2) may further include: a frequency domain transform part that transforms the pieces of sound data in a time domain into a plurality of pieces of sound data in a frequency domain, wherein the estimation part may include a delay time calculation section that calculates a delay time between two different pieces of sound data pair by pair among the pieces of sound data in the frequency domain, and a position estimation section that estimates the position of the emergency vehicle using the respective pieces of positional information of the vehicles, a result of the detection of the siren sound in each of the pieces of sound data, and the delay times calculated from the respective pairs.

A delay time between two different pieces of sound data collected by two different vehicles can be estimated using distances from the two different vehicles to the emergency vehicle. Therefore, the position of the emergency vehicle can be estimated using the estimated delay time between the two different pieces of sound data and an acquired delay time between the two different pieces of sound data.

(5) In the remote monitoring device disclosed in any one of the above-mentioned (1) to (4), the identification part may include an emergency vehicle position storage section that stores the estimated position of the emergency vehicle, a moving direction estimation section that estimates a moving direction of the emergency vehicle on the basis of a previously estimated position of the emergency vehicle which is stored in the emergency vehicle position storage section and the estimated position of the emergency vehicle, and a vehicle identification section that identifies the vehicle approached by the emergency vehicle on the basis of the estimated moving direction of the emergency vehicle and the respective pieces of positional information of the vehicles.

In this configuration, the moving direction of the emergency vehicle is estimated, which makes it possible to identify a vehicle which is on a line extending from the emergency vehicle in the moving direction of the emergency vehicle as the vehicle approached by the emergency vehicle.

(6) In the remote monitoring device disclosed in any one of the above-mentioned (1) to (5), the indication part may indicate a vehicle that is within a predetermined range from the estimated position of the emergency vehicle among the vehicles.

In this configuration, a vehicle that is within a predetermined range from the estimated position of the emergency vehicle among the vehicles is indicated. Thus, a remote supervisor can know the vehicle near the emergency vehicle and supervise the vehicle.

(7) In the remote monitoring device disclosed in any one of the above-mentioned (1) to (6), it may be appreciated that the acquisition part further acquires video data taken by a camera included in each of the vehicles, and the indication part outputs to a display part, in a case where the vehicle approached by the emergency vehicle is identified among the vehicles, the video data taken by the camera included in the vehicle approached by the emergency vehicle.

In this configuration, video data taken by the camera included in the vehicle approached by the emergency vehicle is output to the display part. Thus, the remote supervisor can see the video data displayed on the display part to remotely control the vehicle approached by the emergency vehicle.

(8) In the remote monitoring device disclosed in any one of the above-mentioned (1) to (7), it may be appreciated that the indication part outputs to a display part, in a case where the vehicle approached by the emergency vehicle is identified among the vehicles, an indication image including a map, a plurality of first icons indicative of the respective positions of the vehicles on the map, and a second icon indicative of the estimated position of the emergency vehicle on the map.

In this configuration, in the case where the vehicle approached by the emergency vehicle is identified among the vehicles, the indication image including the map, the first icons respectively indicative of the respective positions of the vehicles on the map, and the second icon indicative of the estimated position of the emergency vehicle on the map is output to the display part.

Therefore, the remote supervisor can see the indication image displayed on the display part to know the position of the emergency vehicle and the respective positions of the vehicles to thereby remotely control the vehicle approached by the emergency vehicle.

(9) In the remote monitoring device disclosed in the above-mentioned (8), the indication part may display a first icon indicative of the position of the vehicle approached by the emergency vehicle on the map in a state different from a state for another first icon indicative of the position of another vehicle not approached by the emergency vehicle on the map.

In this configuration, the first icon indicative of the position of the vehicle approached by the emergency vehicle on the map is represented in the state different from the state for the another first icon indicative of the position of the another vehicle not approached by the emergency vehicle on the map. Consequently, the remote supervisor can easily know the position of the vehicle approached by the emergency vehicle.

(10) In the remote monitoring device disclosed in the above-mentioned (1) to (9), the indication part may output to a speaker, in a case where the vehicle approached by the emergency vehicle is identified among the vehicles, an indication sound for indicating the vehicle approached by the emergency vehicle.

In this configuration, in the case where a vehicle approached by the emergency vehicle is identified among the vehicles, an indication sound for indicating the vehicle approached by the emergency vehicle is output to the speaker. Therefore, the remote supervisor can easily know the presence of the vehicle approached by the emergency vehicle by hearing the indication sound.

Further, the present disclosure may be accomplished not only as the remote monitoring device including the characteristic configuration described above, but also as a remote monitoring method for executing a characteristic process corresponding to the characteristic configuration included in the remote monitoring device. Additionally, the present disclosure may be accomplished as a computer program causing a computer to execute the characteristic process included in the remote monitoring method. Therefore, the same advantageous effects as the remote monitoring device can be established in the following aspects.

(11) A remote monitoring method according to another aspect of the present disclosure is a remote monitoring method by a remote monitoring device for remotely monitoring a plurality of vehicles configured to travel autonomously and under remote control and includes: acquiring a plurality of pieces of positional information indicative of respective positions of the vehicles and a plurality of pieces of sound data indicative of sounds in respective surroundings of the vehicles; performing detection of a siren sound of an emergency vehicle in each of the acquired pieces of sound data; estimating, in a case where the siren sound is detected in pieces of sound data, a position of the emergency vehicle on the basis of the respective pieces of positional information of vehicles and the pieces of sound data; identifying a vehicle approached by the emergency vehicle among the vehicles on the basis of time variation of the estimated position of the emergency vehicle; and indicating the vehicle approached by the emergency vehicle in a case where the vehicle approached by the emergency vehicle is identified among the vehicles.

(12) A remote monitoring program according to still another aspect of the present disclosure is a remote monitoring program for remotely monitoring a plurality of vehicles configured to travel autonomously and travel under remote control, the remote monitoring program causing a computer to serve as: an acquisition part that acquires a plurality of pieces of positional information indicative of respective positions of the vehicles and a plurality of pieces of sound data indicative of sounds in respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

(13) A remote monitoring system according to still another aspect of the present disclosure includes: a plurality of vehicles configured to travel autonomously and travel under remote control; and a remote monitoring device for remotely monitoring the vehicles, wherein each of the vehicles includes: a positional information acquisition part that acquires a piece of positional information indicative of a position of the vehicle; a microphone that acquires a piece of sound data indicative of a sound in surroundings of the vehicle; and a communication part that transmits the piece of positional information and the piece of sound data to the remote monitoring device, and the remote monitoring device includes: an acquisition part that acquires the pieces of positional information indicative of the respective positions of the vehicles and the pieces of sound data indicative of the sounds in the respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

In this configuration, a vehicle approached by the emergency vehicle is identified among the vehicles, and the vehicle approached by the emergency vehicle is indicated. This makes it possible to carry out a prompt and proper remote control of the vehicle approached by the emergency vehicle.

(14) A device according to still another aspect of the present disclosure includes: an acquisition part that acquires a plurality of pieces of positional information indicative of respective positions of a plurality of vehicles and a plurality of pieces of sound data indicative of sounds in respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

(15) A non-transitory computer-readable recording medium according to still another aspect of the present disclosure records a remote monitoring program, and the remote monitoring program is a remote monitoring program for remotely monitoring a plurality of vehicles configured to travel autonomously and travel under remote control, and causes a computer to serve as: an acquisition part that acquires a plurality of pieces of positional information indicative of respective positions of the vehicles and a plurality of pieces of sound data indicative of sounds in respective surroundings of the vehicles; a detection part that performs detection of a siren sound of an emergency vehicle in each of the acquired pieces of sound data; an estimation part that estimates, in a case where the siren sound is detected in pieces of sound data, a position of the emergency vehicle on the basis of the respective pieces of positional information of vehicles and the pieces of sound data; an identification part that identifies a vehicle approached by the emergency vehicle among the vehicles on the basis of time variation of the estimated position of the emergency vehicle; and an indication part that indicates the vehicle approached by the emergency vehicle in a case where the vehicle approached by the emergency vehicle is identified among the vehicles.

Hereinafter, an embodiment of the present disclosure will be described with reference to the accompanied drawings. It should be noted that the below-described embodiment is a specific example of the present disclosure and will not delimit the technical scope of the present disclosure.

### Embodiment

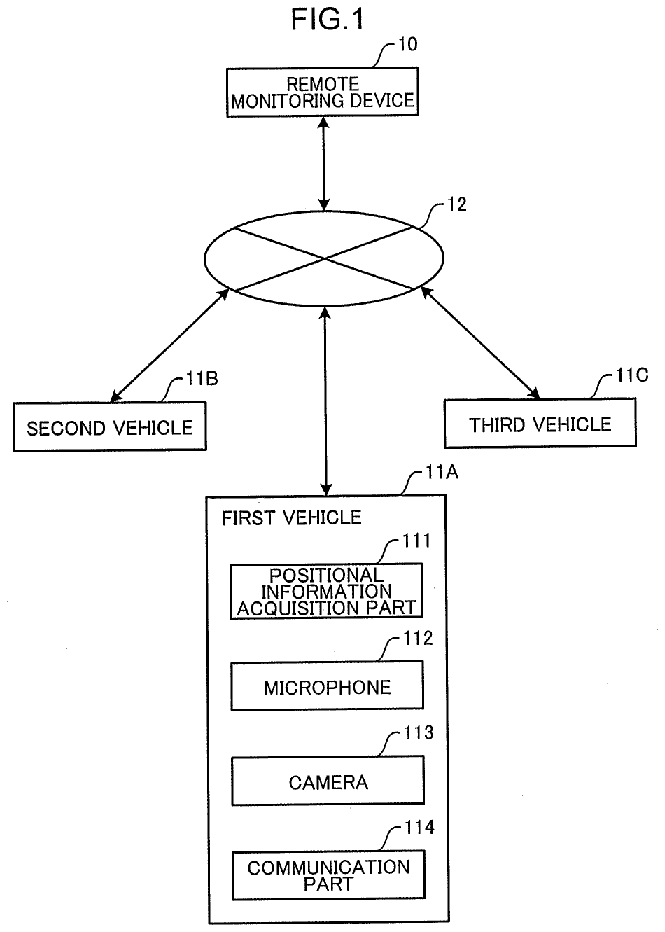

FIG. 1 is a diagram showing a general configuration of a remote monitoring system according to an embodiment of the present disclosure.

The remote monitoring system shown in FIG. 1 includes a remote monitoring device 10, a first vehicle 11A, a second vehicle 11B, and a third vehicle 11C.

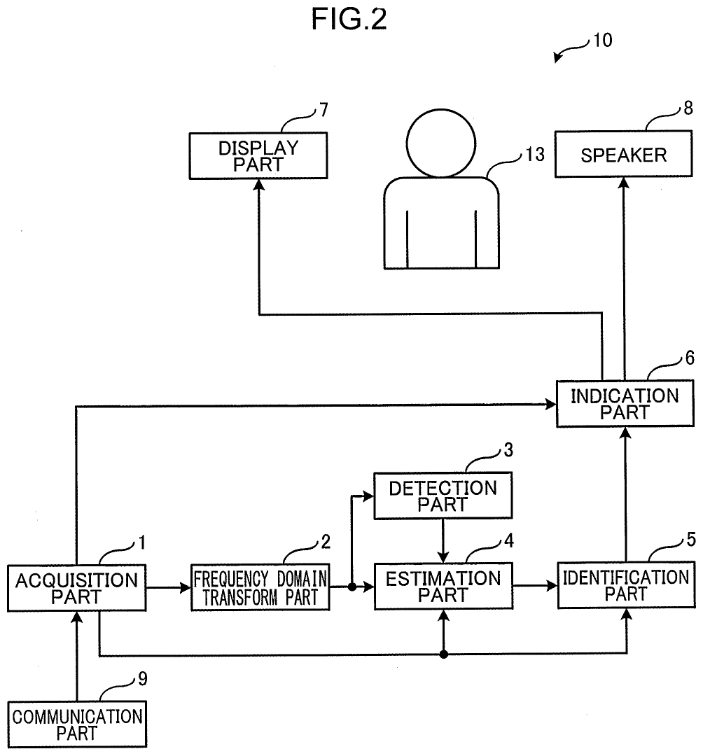

The remote monitoring device 10 is, for example, a personal computer, and is mutually communicably connected to the first vehicle 11A, the second vehicle 11B, and the third vehicle 11C via a network 12. The network 12 includes, for example, Internet. The configuration of the remote monitoring device 10 will be described later with reference to FIG. 2.

The first vehicle 11A, the second vehicle 11B, and the third vehicle 11C include, for example, an electric robot, an electric car, an electric truck, or an electric drone. For example, the first vehicle 11A, the second vehicle 11B, and the third vehicle 11C move within a certain region and transport a package of a user. The first vehicle 11A, the second vehicle 11B, and the third vehicle 11C are supervised by a remote supervisor. The first vehicle 11A, the second vehicle 11B, and the third vehicle 11C are configured to travel autonomously and travel under remote control. Ordinarily, the first vehicle 11A, the second vehicle 11B, and the third vehicle 11C travel autonomously. However, in an emergency, i.e., when being approached by an emergency vehicle, the first vehicle 11A, the second vehicle 11B, and the third vehicle 11C travel under remote control by the remote supervisor by use of the remote monitoring device 10.

In the present embodiment, the remote monitoring system includes three vehicles (the first vehicle 11A, the second vehicle 11B, and the third vehicle 11C). However, the present disclosure is not particularly limited to this embodiment. The remote monitoring system may include two vehicles or four or more vehicles.

The first vehicle 11A, the second vehicle 11B, and the third vehicle 11C have completely the same configuration. Therefore, hereinafter, only the configuration of the first vehicle 11A will be described.

The first vehicle 11A includes a positional information acquisition part 111, a microphone 112, a camera 113, and a communication part 114.

For example, the positional information acquisition part 111 is a GPS (Global Positioning System) receiver, and acquires a piece of positional information indicative of a position of the first vehicle 11A.

The microphone 112 acquires a piece of sound data indicative of a sound in surroundings of the first vehicle 11A.

The camera 113 takes an image of the surroundings of the first vehicle 11A. The camera 113 takes an image of a region in front of, behind, or all around the first vehicle 11A. The first vehicle 11A is not limited to include a single camera 113, but may include a plurality of cameras for photographing regions, e.g., in front of and behind the first vehicle 11A.

The communication part 114 transmits to the remote monitoring device 10 the piece of positional information acquired by the positional information acquisition part 111, the piece of sound data acquired by the microphone 112, and a piece of video data acquired by the camera 113. The communication part 114 periodically transmits a piece of positional information, a piece of sound data, and a piece of video data to the remote monitoring device 10. For example, the communication part 114 may transmit a piece of positional information, a piece of sound data, and a piece of video data to the remote monitoring device 10 every five seconds. In this event, the communication part 114 may transmit the piece of sound data of five second period and the piece of video data of five second period to the remote monitoring device 10.

FIG. 2 is a diagram showing the configuration of the remote monitoring device 10 according to the embodiment of the present disclosure.

The remote monitoring device 10 remotely monitors the vehicles (the first vehicle 11A, the second vehicle 11B, and the third vehicle 11C). The remote monitoring device 10 shown in FIG. 2 includes an acquisition part 1, a frequency domain transform part 2, a detection part 3, an estimation part 4, an identification part 5, an indication part 6, a display part 7, a speaker 8, and a communication part 9.

The communication part 9 receives pieces of positional information, pieces of sound data, and pieces of video data transmitted by the vehicles (the first vehicle 11A, the second vehicle 11B, and the third vehicle 11C) which are remotely monitored.

The acquisition part 1 acquires the pieces of positional information indicative of respective positions of the vehicles and the pieces of sound data indicative of sounds in the respective surroundings of the vehicles. The acquisition part 1 acquires the pieces of positional information and the pieces of sound data from the communication part 9. The acquisition part 1 further acquires the pieces of video data taken by cameras included in the vehicles. The acquisition part 1 acquires the pieces of video data from the communication part 9. The acquisition part 1 outputs the pieces of positional information to the estimation part 4 and the identification part 5, the pieces of sound data to the frequency domain transform part 2, and the pieces of video data to the indication part 6.

The acquisition part 1 acquires the piece of positional information indicative of the position of the first vehicle 11A and first sound data indicative of the sound in the surroundings of the first vehicle 11A. Further, the acquisition part 1 acquires the piece of positional information indicative of the position of the second vehicle 11B and second sound data indicative of the sound in the surroundings of the second vehicle 11B. Further, the acquisition part 1 acquires the piece of positional information indicative of the position of the third vehicle 11C and third sound data indicative of the sound in the surroundings of the third vehicle 11C.

The frequency domain transform part 2 transforms the pieces of sound data of the vehicles acquired by the acquisition part 1 into pieces of sound data in a frequency domain. The frequency domain transform part 2 transforms the pieces of sound data in a time domain acquired by the acquisition part 1 into the pieces of sound data in the frequency domain. The frequency domain transform part 2 transforms the pieces of sound data in the time domain into the pieces of sound data in the frequency domain using fast Fourier transform.

The frequency domain transform part 2 transforms the first sound data in the time domain acquired from the first vehicle 11A into first sound data in the frequency domain. Further, the frequency domain transform part 2 transforms the second sound data in the time domain acquired from the second vehicle 11B into second sound data in the frequency domain. Further, the frequency domain transform part 2 transforms the third sound data in the time domain acquired from the third vehicle 11C into third sound data in the frequency domain.

The detection part 3 performs detection of a siren sound of an emergency vehicle in each of the pieces of sound data transformed in the frequency domain by the frequency domain transform part 2. The detection part 3 performs detection of a siren sound of an emergency vehicle in each of the pieces of sound data. The emergency vehicle is, for example, an ambulance, a fire engine, or a police car. The detection part 3 outputs a result of the detection of a siren sound indicating whether or not a siren sound is detected in each of the pieces of sound data. Details on a configuration of the detection part 3 will be described later.

In a case where a siren sound is detected in pieces of sound data, the estimation part 4 estimates a position of the emergency vehicle on the basis of the respective pieces of positional information of vehicles and the pieces of sound data. In the case where a siren sound of the emergency vehicle is detected by the detection part 3 in pieces of sound data, the estimation part 4 estimates a position of the emergency vehicle on the basis of the pieces of sound data transformed in the frequency domain by the frequency domain transform part 2 and the respective pieces of positional information of the vehicles acquired by the acquisition part 1. The estimation part 4 outputs positional information indicative of the estimated position of the emergency vehicle. Details on a configuration of the estimation part 4 will be described later.

The identification part 5 identifies a vehicle approached by the emergency vehicle among the vehicles on the basis of time variation of the position of the emergency vehicle estimated by the estimation part 4. The identification part 5 estimates a moving direction of the emergency vehicle on the basis of the time variation of the position of the emergency vehicle estimated by the estimation part 4, and identifies the vehicle approached by the emergency vehicle using the estimated moving direction of the emergency vehicle. The identification part 5 outputs information for discriminating the identified vehicle approached by the emergency vehicle. Details on a configuration of the identification part 5 will be described later.

In a case where a vehicle approached by the emergency vehicle is identified among the vehicles by the identification part 5, the indication part 6 indicates the vehicle approached by the emergency vehicle. The indication part 6 indicates to a remote supervisor 13 the vehicle approached by the emergency vehicle using a result of the identification of the vehicle approached by the emergency vehicle by the identification part 5, the pieces of video data acquired by the acquisition part 1, and the pieces of positional information of the vehicles acquired by the acquisition part 1.

In the case where a vehicle approached by the emergency vehicle is identified among the vehicles, the indication part 6 outputs to the display part 7 an indication image including a map, a plurality of first icons indicative of the respective positions of the vehicles on the map, and a second icon indicative of the estimated position of the emergency vehicle on the map. The indication part 6 displays a first icon indicative of the position of the vehicle approached by the emergency vehicle on the map in a state different from a state for another first icon indicative of the position of another vehicle not approached by the emergency vehicle on the map. For example, the indication part 6 emphasizes the first icon indicative of the position of the vehicle approached by the emergency vehicle on the map. Further, in the case where a vehicle approached by the emergency vehicle is identified among the vehicles, the indication part 6 outputs to the display part 7 the video data taken by the camera included in the vehicle approached by the emergency vehicle.

Further, in the case where a vehicle approached by the emergency vehicle is identified among the vehicles, the indication part 6 outputs to the speaker 8 an indication sound for indicating the vehicle approached by the emergency vehicle.

The display part 7 is, for example, a liquid crystal display device, and displays an indication image and video data which are output by the indication part 6.

The speaker 8 externally outputs the indication sound output by the indication part 6.

The remote supervisor 13 supervises the indication image displayed on the display part 7 and the indication sound output from the speaker 8, and remotely controls the vehicle as needed.

In the present embodiment, the remote monitoring device 10 includes the display part 7 and the speaker 8. However, the present disclosure is not particularly limited to this embodiment. The remote monitoring device 10 may include only the display part 7 and may not include the speaker 8. Further, the remote monitoring device 10 may include only the speaker 8 and may not include the display part 7. Further, the remote monitoring device 10 may include neither the display part 7 nor the speaker 8 but may be connected to the display part 7 and the speaker 8 which are provided externally.

The remote monitoring device 10 may further include an operation part that receives a remote control of the vehicle by the remote supervisor 13. The operation part receives a selection by the remote supervisor 13 of a vehicle to remotely control among the vehicles, and receives a remote control of the selected vehicle. For example, the remote supervisor 13 remotely controls the vehicle approached by the emergency vehicle to move the vehicle to a place where the vehicle does not obstruct the passage of the emergency vehicle.

Hereinafter, the details on the configuration of the detection part 3 shown in FIG. 2 will be described.

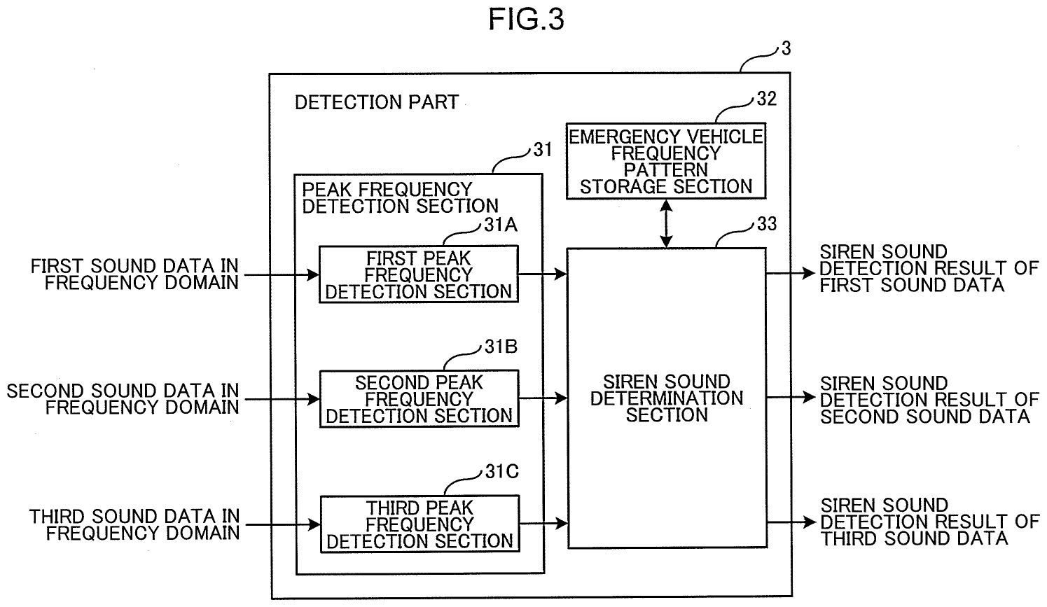

FIG. 3 is a block diagram showing a specific configuration of the detection part 3 of the embodiment of the present disclosure.

The detection part 3 includes a peak frequency detection section 31, an emergency vehicle frequency pattern storage section 32, and a siren sound determination section 33.

The peak frequency detection section 31 detects a peak frequency in a frequency spectrum of each of the pieces of sound data in the frequency domain. The peak frequency detection section 31 includes a first peak frequency detection section 31A, a second peak frequency detection section 31B, and a third peak frequency detection section 31C.

The first peak frequency detection section 31A detects a peak frequency in a frequency spectrum of the first sound data in the frequency domain of the sound collected by the first vehicle 11A.

The second peak frequency detection section 31B detects a peak frequency in a frequency spectrum of the second sound data in the frequency domain of the sound collected by the second vehicle 11B.

The third peak frequency detection section 31C detects a peak frequency in a frequency spectrum of the third sound data in the frequency domain of the sound collected by the third vehicle 11C.

The emergency vehicle frequency pattern storage section 32 stores in advance a frequency pattern having a peak frequency of each of a plurality of siren sounds varying according to types of emergency vehicles, e.g., an ambulance, a fire engine, and a police car. The siren sounds vary according to the types of emergency vehicles.

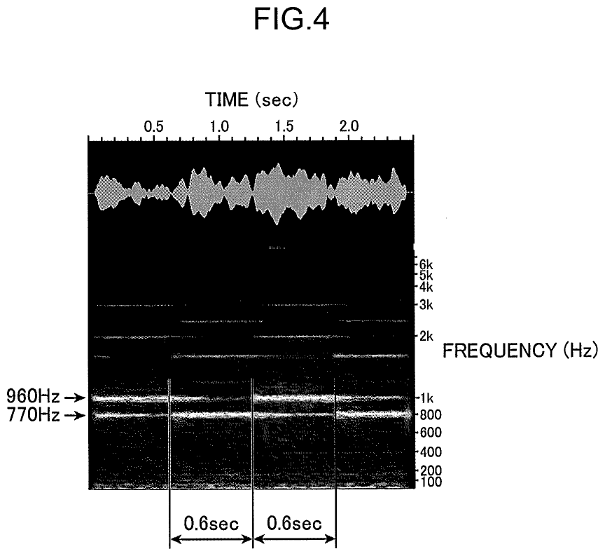

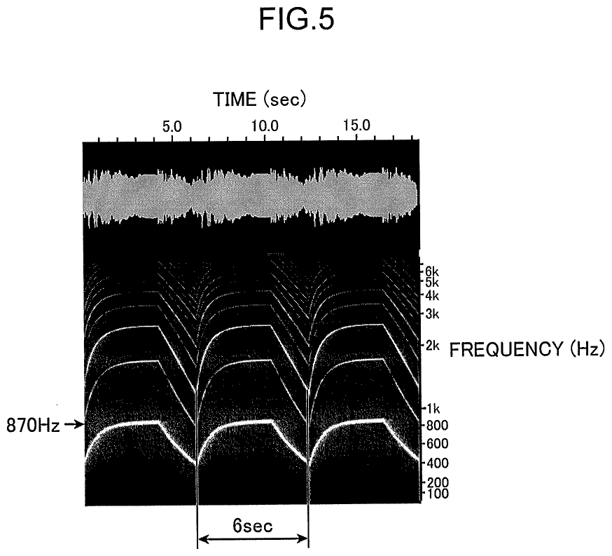

FIG. 4 is a graph representing exemplary sound waveform and frequency spectrogram of a siren sound of an ambulance and FIG. 5 is a graph representing exemplary sound waveform and frequency spectrogram of a siren sound of a police car.

As shown in FIG. 4, in the siren sound of the ambulance, a first peak frequency at substantially 960 Hz is continuously detected for approximately 0.6 seconds, and thereafter, a second peak frequency at substantially 770 Hz is continuously detected for approximately 0.6 seconds. The siren sound of the ambulance has a frequency pattern that repeats the first peak frequency and the second peak frequency lower than the first peak frequency every predetermined period.

Besides, as shown in FIG. 5, the siren sound of the police car shows an increase from a first peak frequency at substantially 400 Hz to a second peak frequency at substantially 870 Hz and a decrease from the second peak frequency to the first peak frequency in approximately 6 seconds. The siren sound of the police car has a frequency pattern that shows the increase from the first peak frequency to the second peak frequency and the decrease from the second peak frequency to the first peak frequency in a certain period.

The siren sound determination section 33 compares respective frequency patterns of peak frequencies of the respective pieces of sound data detected by the peak frequency detection section 31 with each of the frequency patterns of the peak frequencies of the respective types of the emergency vehicles stored in the emergency vehicle frequency pattern storage section 32 and determines whether each of the pieces of sound data includes a siren sound of an emergency vehicle.

The siren sound determination section 33 analyzes the frequency patterns of the peak frequencies detected in the respective pieces of sound data by the peak frequency detection section 31. The siren sound determination section 33 compares the respective frequency patterns of the peak frequencies detected in the respective pieces of sound data by the peak frequency detection section 31 with each of the frequency patterns stored in the emergency vehicle frequency pattern storage section 32. Further, in a case where a frequency pattern of the detected peak frequency matches one of the frequency patterns stored in the emergency vehicle frequency pattern storage section 32, the siren sound determination section 33 determines that the piece of sound data having the detected peak frequency includes a siren sound.

More specifically, the siren sound determination section 33 analyzes a frequency pattern of the peak frequency detected in the first sound data by the first peak frequency detection section 31A. The siren sound determination section 33 compares the frequency pattern of the peak frequency detected in the first sound data with each of the frequency patterns stored in the emergency vehicle frequency pattern storage section 32. In a case where the frequency pattern of the peak frequency detected in the first sound data matches one of the frequency patterns stored in the emergency vehicle frequency pattern storage section 32, the siren sound determination section 33 determines that the first sound data having the detected peak frequency includes the siren sound.

Further, the siren sound determination section 33 analyzes a frequency pattern of the peak frequency detected in the second sound data by the second peak frequency detection section 31B. The siren sound determination section 33 compares the frequency pattern of the peak frequency detected in the second sound data with each of the frequency patterns stored in the emergency vehicle frequency pattern storage section 32. In a case where the frequency pattern of the peak frequency detected in the second sound data matches one of the frequency patterns stored in the emergency vehicle frequency pattern storage section 32, the siren sound determination section 33 determines that the second sound data having the detected peak frequency includes the siren sound.

Further, the siren sound determination section 33 analyzes a frequency pattern of the peak frequency detected in the third sound data by the third peak frequency detection section 31C. The siren sound determination section 33 compares the frequency pattern of the peak frequency detected in the third sound data with each of the frequency patterns stored in the emergency vehicle frequency pattern storage section 32. In a case where the frequency pattern of the peak frequency detected in the third sound data matches one of the frequency patterns stored in the emergency vehicle frequency pattern storage section 32, the siren sound determination section 33 determines that the third sound data having the detected peak frequency includes the siren sound.

The siren sound determination section 33 outputs a siren sound detection result indicating whether each of the pieces of sound data includes a siren sound. The siren sound determination section 33 outputs a siren sound detection result of the first sound data, a siren sound detection result of the second sound data, and a siren sound detection result of the third sound data.

The siren sound determination section 33 may add to the siren sound detection result a type of an emergency vehicle having a frequency pattern matching the frequency pattern of the peak frequencies detected in the pieces of sound data.

Further, the siren sound determination section 33 may output to the indication part 6 the type of the emergency vehicle having the frequency pattern matching the frequency pattern of the peak frequencies detected in the pieces of sound data. The indication part 6 may indicate the type of the emergency vehicle. For example, the indication part 6 may output to the display part 7 information indicating which of an ambulance, a fire engine, and a police car is approaching.

Hereinafter, the details on the configuration of the estimation part 4 shown in FIG. 2 will be described.

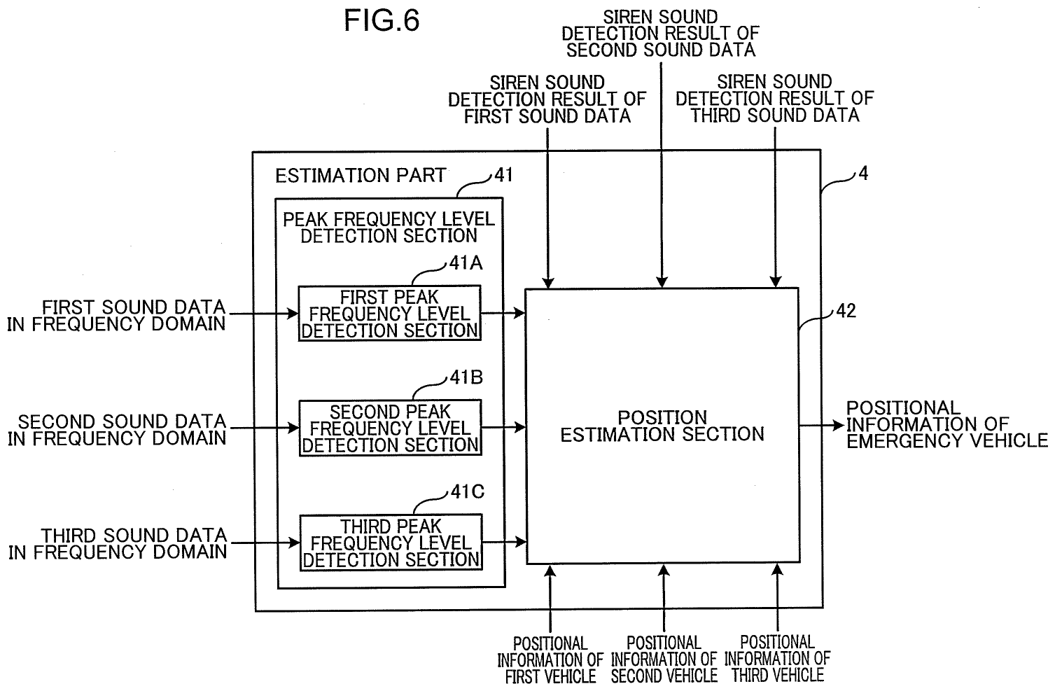

FIG. 6 is a block diagram showing a specific configuration of the estimation part 4 of the embodiment of the present disclosure. FIG. 6 shows the estimation part 4 configured for a case where three vehicles are remotely monitored. However, the number of vehicles to be remotely monitored is not limited to three.

The estimation part 4 includes a peak frequency level detection section 41 and a position estimation section 42.

The peak frequency level detection section 41 detects a level of the peak frequency in the frequency spectrum of each of the pieces of sound data in the frequency domain. The peak frequency level detection section 41 includes a first peak frequency level detection section 41A, a second peak frequency level detection section 41B, and a third peak frequency level detection section 41C.

The first peak frequency level detection section 41A detects a level of the peak frequency in the frequency spectrum of the first sound data in the frequency domain of the sound collected by the first vehicle 11A.

The second peak frequency level detection section 41B detects a level of the peak frequency in the frequency spectrum of the second sound data in the frequency domain of the sound collected by the second vehicle 11B.

The third peak frequency level detection section 41C detects a level of the peak frequency in the frequency spectrum of the third sound data in the frequency domain of the sound collected by the third vehicle 11C.

The position estimation section 42 estimates the position of the emergency vehicle using the respective pieces of positional information of the vehicles, the siren sound detection results in the respective pieces of sound data, and the levels of the respective peak frequencies detected in the pieces of sound data.

More specifically, the position estimation section 42 estimates the position of the emergency vehicle using the positional information of the first vehicle 11A, the positional information of the second vehicle 11B, the positional information of the third vehicle 11C, the siren sound detection result of the first sound data, the siren sound detection result of the second sound data, the siren sound detection result of the third sound data, the level of the peak frequency detected in the first sound data, the level of the peak frequency detected in the second sound data, and the level of the peak frequency detected in the third sound data.

The position estimation section 42 identifies a plurality of pieces of sound data in which the siren sound is detected on the basis of the siren sound detection results in the respective pieces of sound data. The position estimation section 42 estimates the position of the emergency vehicle using pieces of positional information of vehicles in which the identified pieces of sound data are collected, and levels of the peak frequencies detected in the identified pieces of sound data.

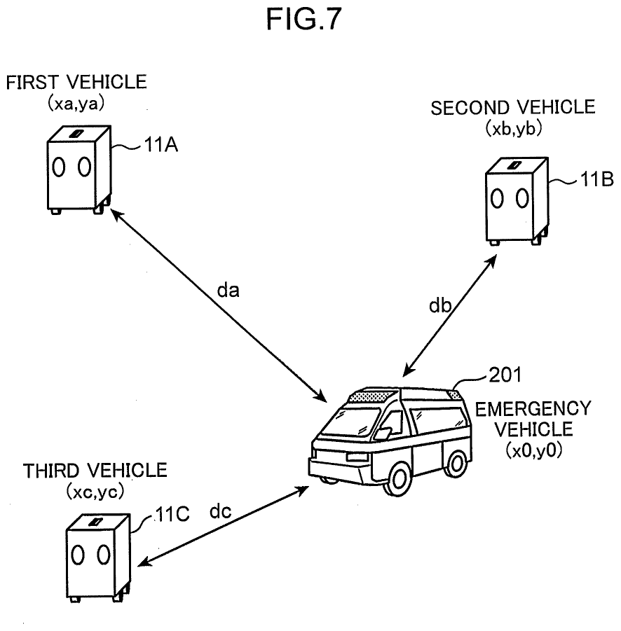

FIG. 7 is a schematic illustration of a process of estimating a position of an emergency vehicle.

In FIG. 7, an emergency vehicle 201 travels near the first vehicle 11A, the second vehicle 11B, and the third vehicle 11C. The first sound data, the second sound data, and the third sound data, which are respectively collected by the first vehicle 11A, the second vehicle 11B, and the third vehicle 11C, include a siren sound of the emergency vehicle 201. When a position of the first vehicle 11A is (xa, ya), a position of the second vehicle 11B is (xb, yb), a position of the third vehicle 11C is (xc, yc), and a position of the emergency vehicle 201 is (x0, y0), respective distances da, db, and dc from the first vehicle 11A, the second vehicle 11B, and the third vehicle 11C to the emergency vehicle 201 are expressed by the following Equations (1) to (3). The pieces of positional information of the first vehicle 11A, the second vehicle 11B, and the third vehicle 11C are known, and are acquired by the acquisition part 1.

$${da}^{2} = {( x 0 - x a )}^{2} + {( y 0 - ya )}^{2} \qquad ( 1 )$$

$${db}^{2} = {( x 0 - x b )}^{2} + {( y 0 - yb )}^{2} \qquad ( 2 )$$

$${dc}^{2} = {( x 0 - xc )}^{2} + {( y 0 - yc )}^{2} \qquad ( 3 )$$

When levels of peak frequencies respectively detected in the first sound data, the second sound data, and the third sound data collected by the first vehicle 11A, the second vehicle 11B, and the third vehicle 11C are Pa, Pb, and Pc, since a loudness of a sound is proportional to a reciprocal of a distance, Pa, Pb, Pc, da, db, and dc are respectively expressed by Pa: Pb=1/da: 1/db, Pb: Pc=1/db: 1/dc; and Pc: Pa=1/dc: 1/da. By rearranging the respective equations, relationships among the distances da, db, and dc are expressed by the following Equations (4) to (6) using Pa, Pb, and Pc.

$$da / db = Pb / Pa \qquad ( 4 )$$

$$db / dc = Pc / Pb \qquad ( 5 )$$

$$dc / da = Pa / Pc \qquad ( 6 )$$

The position estimation section 42 sequentially scans positions (x, y) on a predetermined map, substitutes x into x0 and substitutes y into y0 in Expressions (1) to (3) to thereby calculate respective da, db, and dc. A size of the predetermined map, i.e., a range of the positions (x, y) where the scan is performed, is set on the basis of positions of the vehicles (the first vehicle 11A, the second vehicle 11B, and the third vehicle 11C) from which the pieces of sound data, including the detected siren sound of the emergency vehicle, are obtained. For example, a predetermined range from the vehicles (the first vehicle 11A, the second vehicle 11B, and the third vehicle 11C) may be set as a scan range. The position estimation section 42 calculates da/db, db/dc, and dc/da using the calculated da, db, and dc. The position estimation section 42 calculates a difference between da/db and Pb/Pa, a difference between db/dc and Pb/Pc, and a difference between dc/da and Pc/Pa in all the positional coordinates on the predetermined map. The position estimation section 42 calculates as the position (x0, y0) of the emergency vehicle a position (x, y) in which there are the smallest calculated differences between da/db, db/dc, dc/da and Pb/Pa, Pb/Pc, Pc/Pa, respectively.

Specifically, the position estimation section 42 sequentially calculates da/db, db/dc, and dc/da in respective coordinate positions from a left upper end coordinate position to a right lower end coordinate position on the predetermined map. The position estimation section 42 calculates as the position (x0, y0) of the emergency vehicle the coordinate position in which the difference between da/db and Pb/Pa, the difference between db/dc and Pb/Pc, and the difference between dc/da and Pc/Pa are closest to zero, respectively.

The position of the emergency vehicle is not limited into the estimation on the basis of three vehicles but may be estimated in the same manner also on the basis of four or more vehicles.

Hereinafter, the details on the configuration of an estimation part of a modification will be described.

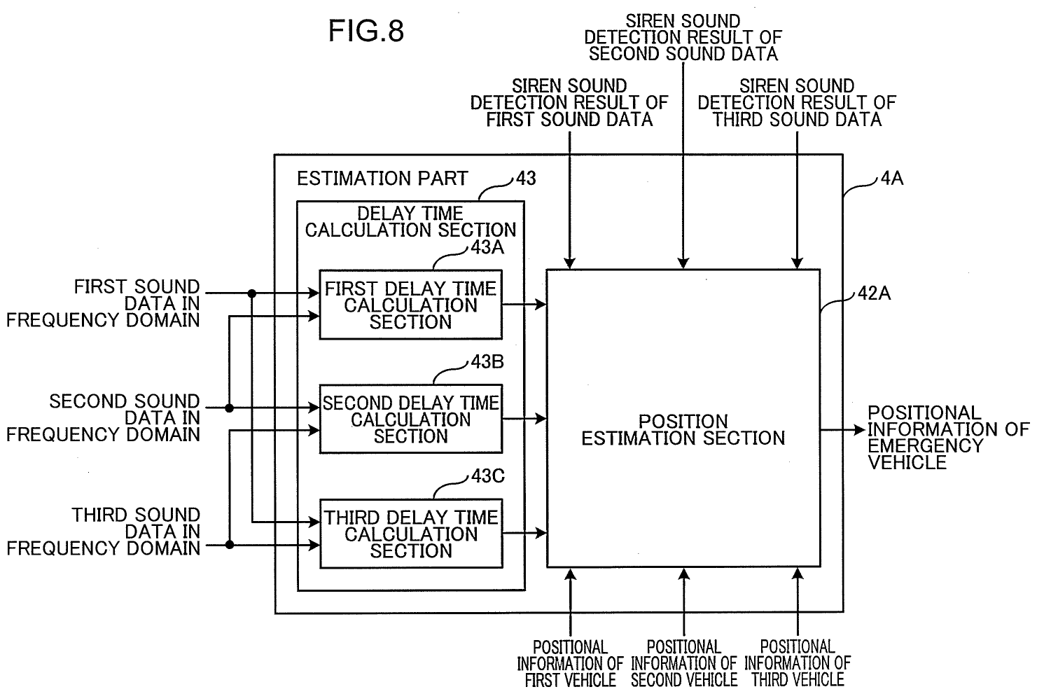

FIG. 8 is a block diagram showing a specific configuration of an estimation part 4A of the modification of the present disclosure. The estimation part 4A of the modification estimates a position of the emergency vehicle on the basis of a difference in arrival time of sound from the emergency vehicle between vehicles.

The estimation part 4A includes a delay time calculation section 43 and a position estimation section 42A.

The delay time calculation section 43 calculates a delay time between two different pieces of sound data pair by pair among the pieces of sound data in the frequency domain. The delay time calculation section 43 includes a first delay time calculation section 43A, a second delay time calculation section 43B, and a third delay time calculation section 43C.

The first delay time calculation section 43A calculates a delay time in arrival of a siren sound of the emergency vehicle at the second vehicle 11B compared to an arrival of the siren sound of the emergency vehicle at the first vehicle 11A on the basis of the first sound data in the frequency domain of the sound collected by the first vehicle 11A and the second sound data in the frequency domain of the sound collected by the second vehicle 11B. The first delay time calculation section 43A calculates a delay time between the first sound data and the second sound data. The first delay time calculation section 43A divides the second sound data in the frequency domain of the sound collected by the second vehicle 11B by the first sound data in the frequency domain of the sound collected by the first vehicle 11A, transforms a result obtained from the division into a piece of sound data in the time domain, and calculates an impulse response of the piece of sound data transformed into the time domain to thereby obtain a delay time in the siren sound at the second vehicle 11B compared to the first vehicle 11A.

The second delay time calculation section 43B calculates a delay time in an arrival of the siren sound of the emergency vehicle at the third vehicle 11C compared to the arrival of the siren sound of the emergency vehicle at the second vehicle 11B. The second delay time calculation section 43B calculates a delay time between the second sound data and the third sound data. The way of calculating the delay time by the second delay time calculation section 43B is the same as the way of calculating the delay time by the first delay time calculation section 43A.

The third delay time calculation section 43C calculates a delay time in the arrival of the siren sound of the emergency vehicle at the first vehicle 11A compared to the arrival of the siren sound of the emergency vehicle at the third vehicle 11C. The third delay time calculation section 43C calculates a delay time between the third sound data and the first sound data. The way of calculating the delay time by the third delay time calculation section 43C is the same as the way of calculating the delay time by the first delay time calculation section 43A.

The position estimation section 42A estimates the position of the emergency vehicle using the pieces of positional information of the vehicles, a result of the detection of the siren sound in each of the pieces of sound data, and the delay times calculated from the respective pairs.

More specifically, the position estimation section 42A estimates the position of the emergency vehicle using the positional information of the first vehicle 11A, the positional information of the second vehicle 11B, the positional information of the third vehicle 11C, the siren sound detection result of the first sound data, the siren sound detection result of the second sound data, the siren sound detection result of the third sound data, the delay time at the second sound data compared to the first sound data, the delay time at the third sound data compared to the second sound data, and the delay time at the first sound data compared to the third sound data.

The position estimation section 42A identifies pieces of sound data in which the siren sound is detected on the basis of the siren sound detection results of the respective pieces of sound data. The position estimation section 42A estimates the position of the emergency vehicle using pieces of positional information of vehicles in which the identified pieces of sound data are collected, and a delay time calculated using the identified pieces of sound data.

The respective distances da, db, and dc from the first vehicle 11A, the second vehicle 11B, and the third vehicle 11C to the emergency vehicle 201 are expressed by the Equations (1) to (3) shown above.

When the delay time in sound data at the second vehicle 11B compared to the first vehicle 11A, the delay time in sound data at the third vehicle 11C compared to the second vehicle 11B, the delay time in sound data at the first vehicle 11A compared to the third vehicle 11C are respectively denoted by LT1, LT2, and LT3, the relationships among the distances da, db, and dc are expressed by the following Equations (7) to (9) using LT1, LT2, and LT3. Where c denotes a speed of sound (340 m/sec).

$$LT 1 = ( db - da ) / c \qquad ( 7 )$$

$$LT 2 = ( db - db ) / c \qquad ( 8 )$$

$$LT 3 = ( da - dc ) / c \qquad ( 9 )$$

The position estimation section 42A sequentially scans positions (x, y) on the predetermined map, substitutes x into x0 and substitutes y into y0 in Expressions (1) to (3) to thereby calculate respective da, db, and dc. The position estimation section 42A calculates (db−da)/c, (dc−db)/c, and (da−dc)/c using the calculated da, db, and dc. The position estimation section 42A calculates a difference between a value obtained from (db−da)/c and the delay time LT1, a difference between a value obtained from (dc−db)/c and the delay time LT2, and a difference between a value obtained from (da−dc)/c and the delay time LT3 in all the positional coordinates on the predetermined map. The position estimation section 42A estimates as the position (x0, y0) of the emergency vehicle a position (x, y) in which there are the smallest calculated differences between the values obtained from (db−da)/c, (dc−db)/c, (da−dc)/c and the delay times LT1, LT2, LT3 respectively calculated by the first delay time calculation section 43A, the second delay time calculation section 43B, and the third delay time calculation section 43C.

Specifically, the position estimation section 42A sequentially calculates (db−da)/c, (dc−db)/c, and (da−dc)/c in the respective coordinate positions from the left upper end coordinate position to the right lower end coordinate position on the predetermined map. The position estimation section 42A estimates as the position (x0, y0) of the emergency vehicle the coordinate position in which the difference between (db−da)/c and LT1, the difference between (dc−db)/c and LT2, and the difference between (da−dc)/c and LT3 are closest to zero, respectively.

The position of the emergency vehicle is not limited to be estimated on the basis of three vehicles but can be estimated in the same manner also on the basis of four or more vehicles.

Further, the delay time calculation section 43 may limit frequency spectra of pieces of sound data to a bandwidth (e.g., 300 Hz to 1200 Hz) of the siren sound of the emergency vehicle to attenuate frequencies other than the siren sound, divides the frequency spectra of sound data, and transform into a piece of sound data in the time domain. This can reduce noise components other than the siren sound of the emergency vehicle, enabling thus a more accurate calculation of the delay time.

Hereinafter, the details on the configuration of the identification part 5 shown in FIG. 2 will be described.

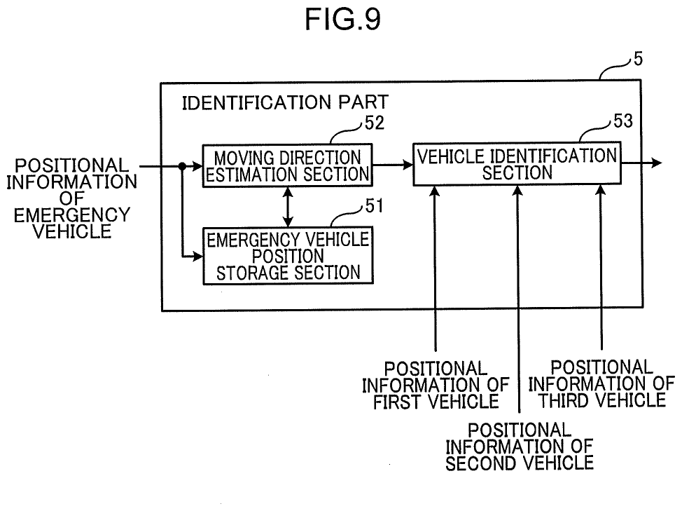

FIG. 9 is a block diagram showing a specific configuration of the identification part 5 according to the embodiment of the present disclosure.

The identification part 5 includes an emergency vehicle position storage section 51, a moving direction estimation section 52, and a vehicle identification section 53.

The emergency vehicle position storage section 51 stores the position of the emergency vehicle estimated by the estimation part 4.

The moving direction estimation section 52 estimates a moving direction of the emergency vehicle on the basis of time variation of the position of the emergency vehicle estimated by the estimation part 4. The moving direction estimation section 52 estimates the moving direction of the emergency vehicle on the basis of a previously estimated position of the emergency vehicle which is stored in the emergency vehicle position storage section 51 and the estimated position of the emergency vehicle.

The vehicle identification section 53 identifies the vehicle approached by the emergency vehicle on the basis of the moving direction of the emergency vehicle estimated by the moving direction estimation section 52 and the respective pieces of positional information of the vehicles.

The vehicle identification section 53 identifies a vehicle which is on a line extending from the emergency vehicle in the moving direction of the emergency vehicle as the vehicle approached by the emergency vehicle. The vehicle identification section 53 may identify as the vehicle approached by the emergency vehicle a vehicle which is on the line extending from the emergency vehicle in the moving direction of the emergency vehicle and is on a road (link) where the emergency vehicle is present.

Further, the identification part 5 may further include a vehicle position storage section that stores the pieces of positional information of the vehicles and a vehicle moving direction estimation section that estimates moving directions of the vehicles. The vehicle moving direction estimation section may estimate the respective moving directions of the vehicles on the basis of previously acquired respective positions of the vehicles which are stored in the vehicle position storage section and the acquired respective positions of the vehicles. The vehicle identification section 53 may determine whether the line extending from the emergency vehicle in the moving direction of the emergency vehicle intersects respective extension lines in the moving directions of the vehicles. The vehicle identification section 53 may identify as the vehicle approached by the emergency vehicle a vehicle whose extension line in the moving direction intersects the extension line in the moving direction of the emergency vehicle.

Further, in the present embodiment and the modification thereof, the acquisition part 1, the frequency domain transform part 2, the peak frequency detection section 31, the siren sound determination section 33, the peak frequency level detection section 41, the position estimation sections 42, 42A, the delay time calculation section 43, the moving direction estimation section 52, and the vehicle identification section 53 are embodied by a processor. The processor includes, for example, a Central Processing Unit (CPU).

Further, in the present embodiment, the emergency vehicle frequency pattern storage section 32 and the emergency vehicle position storage section 51 are embodied by a memory. The memory includes, for example, ROM (Read Only Memory) or EEPROM (Electrically Erasable Programmable Read Only Memory).

Hereinafter, operations of a remote monitoring process in the remote monitoring device 10 of the embodiment of the present disclosure will be described.

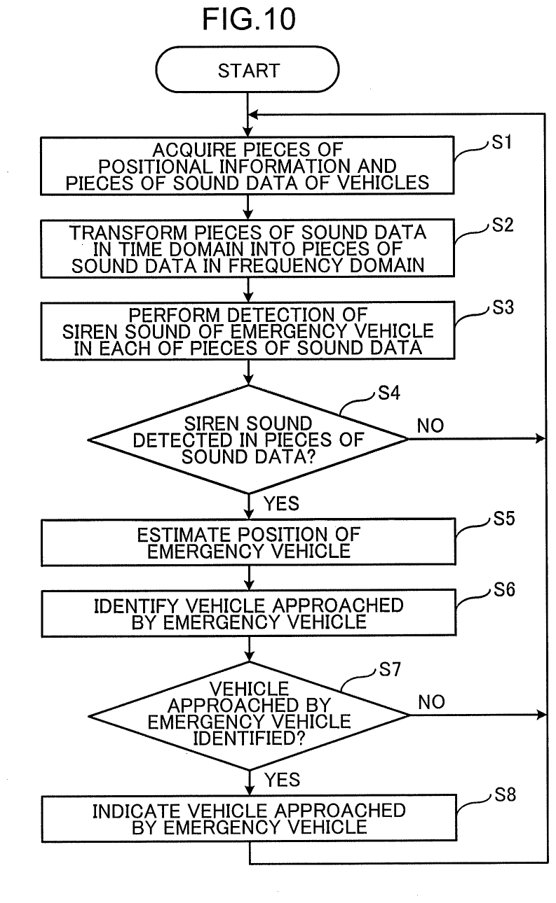

FIG. 10 is a flowchart illustrating operations of the remote monitoring process in the remote monitoring device 10 of the embodiment of the present disclosure.

First, in Step S1, the acquisition part 1 acquires pieces of positional information and pieces of sound data of the vehicles. The acquisition part 1 acquires the pieces of positional information and the pieces of sound data of each of the vehicles which are received by the communication part 9.

Next, in Step S2, the frequency domain transform part 2 transforms the pieces of sound data in the time domain acquired by the acquisition part 1 into pieces of sound data in the frequency domain.

Next, in Step S3, the detection part 3 performs detection of a siren sound of an emergency vehicle in each of the pieces of sound data in the frequency domain.

Next, in Step S4, the estimation part 4 determines whether a siren sound is detected in each of the pieces of sound data. The estimation part 4 may determine whether a siren sound is detected in all the pieces of sound data. Further, the estimation part 4 may determine whether a siren sound is detected in a certain number of pieces of sound data or more among the pieces of sound data. The certain number is, for example, two or three. Two pieces of sound data enable an estimation of a position of an emergency vehicle. Three or more pieces of sound data enable a reliable estimation of a position of an emergency vehicle.

In a case of determination that a siren sound is not detected in pieces of sound data (NO in Step S4), the flow returns to Step S1.

On the other hand, in a case of determination that a siren sound is detected in pieces of sound data (YES in Step S4), the estimation part 4 estimates a position of the emergency vehicle on the basis of the pieces of positional information of the vehicles and the pieces of sound data in Step S5.

Next, in Step S6, the identification part 5 identifies a vehicle approached by the emergency vehicle among the vehicles on the basis of time variation of the position of the emergency vehicle estimated by the estimation part 4.

Next, in Step S7, the indication part 6 determines whether a vehicle approached by the emergency vehicle is identified among the vehicles by the identification part 5. There is a case where, although the pieces of sound data collected by the vehicles include the siren sound, none of the vehicles is approached by the emergency vehicle. In this case, an indication to the remote supervisor is not necessary. Therefore, the indication part 6 determines whether a vehicle approached by the emergency vehicle is identified among the vehicles.

In a case of determination that no vehicle approached by the emergency vehicle is identified (NO in Step S7), the flow returns to Step S1.

On the other hand, in a case of determination that a vehicle approached by the emergency vehicle is identified (YES in Step S7), in Step S8, the indication part 6 indicates the vehicle approached by the emergency vehicle.

In this manner, a vehicle approached by the emergency vehicle is identified among the vehicles, and the vehicle approached by the emergency vehicle is indicated. This makes it possible to carry out a prompt and proper remote control of the vehicle approached by the emergency vehicle.

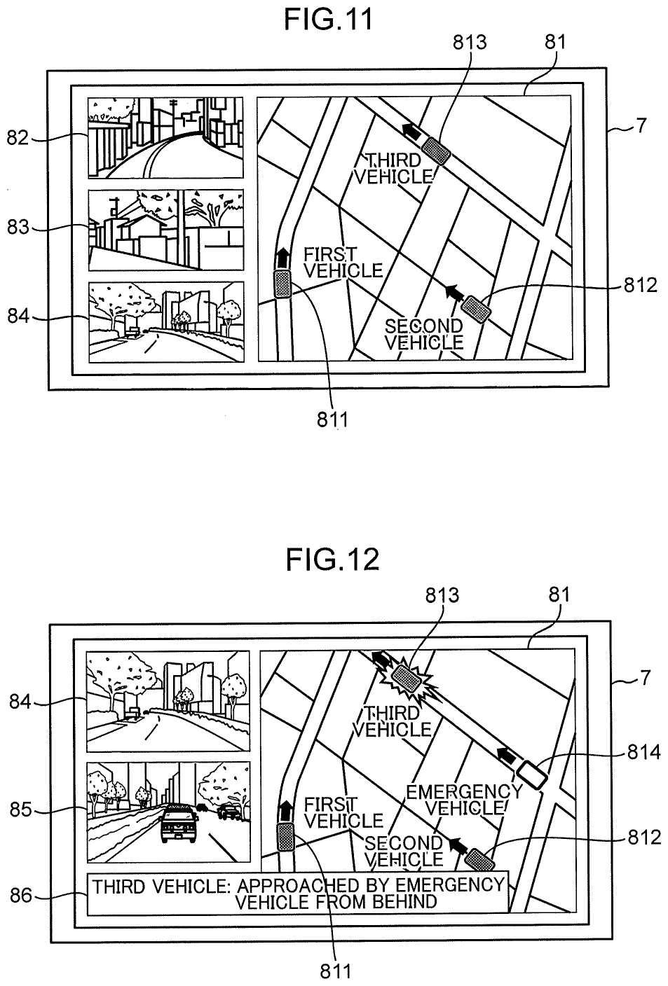

FIG. 11 is an illustration showing another exemplary display screens displayed on the display part 7 in the ordinary mode in which no emergency vehicle is approaching. FIG. 12 is an illustration showing exemplary display screens displayed on the display part 7 in the emergency vehicle approach mode in which an emergency vehicle is approaching.

In the ordinary mode in FIG. 11, the display part 7 displays a map image 81 indicative of positions of the vehicles on a map, and videos 82, 83, and 84 that capture images in front of (in respective moving directions of) the vehicles. First icons 811, 812, and 813 respectively indicative of the positions of the vehicles (the first vehicle, the second vehicle, and the third vehicle) are displayed on the map image 81. In a case where a vehicle approached by an emergency vehicle is identified in pieces of sound data, the display screens change with an automatic transition from the ordinary mode in FIG. 11 to the emergency vehicle approach mode in FIG. 12.

In the ordinary mode, the display part 7 may further show arrows indicative of respective moving directions of the vehicles.

In the emergency vehicle approach mode in FIG. 12, the display part 7 displays the map image 81, the videos 84, 85 that capture images in front of and behind the vehicle (the third vehicle in FIG. 12) approached by the emergency vehicle, and an image 86 indicating the vehicle approached by the emergency vehicle and a direction from which the emergency vehicle is approaching. On the map image 81, the first icons 811, 812, 813 indicating the positions of the vehicles (the first vehicle, the second vehicle, and the third vehicle) and the second icon 814 indicating the position of the emergency vehicle are shown. Further, the first icon 813 indicating the vehicle approached by the emergency vehicle is shown emphasized. For F example, the first icon 813 is shown decorated, blinking, or in a color different from a color of the other first icons 811, 812 so as to be perceivable on the map.

In the emergency vehicle approach mode, the display part 7 may further show an arrow indicative of a moving direction of the emergency vehicle. In the emergency vehicle approach mode, the display part 7 may further display arrows indicative of respective moving directions of the vehicles.

Further, in a case where there is a vehicle approached by the emergency vehicle as shown in FIG. 12, the speaker 8 may indicate with a sound the vehicle approached by the emergency vehicle to the remote supervisor.

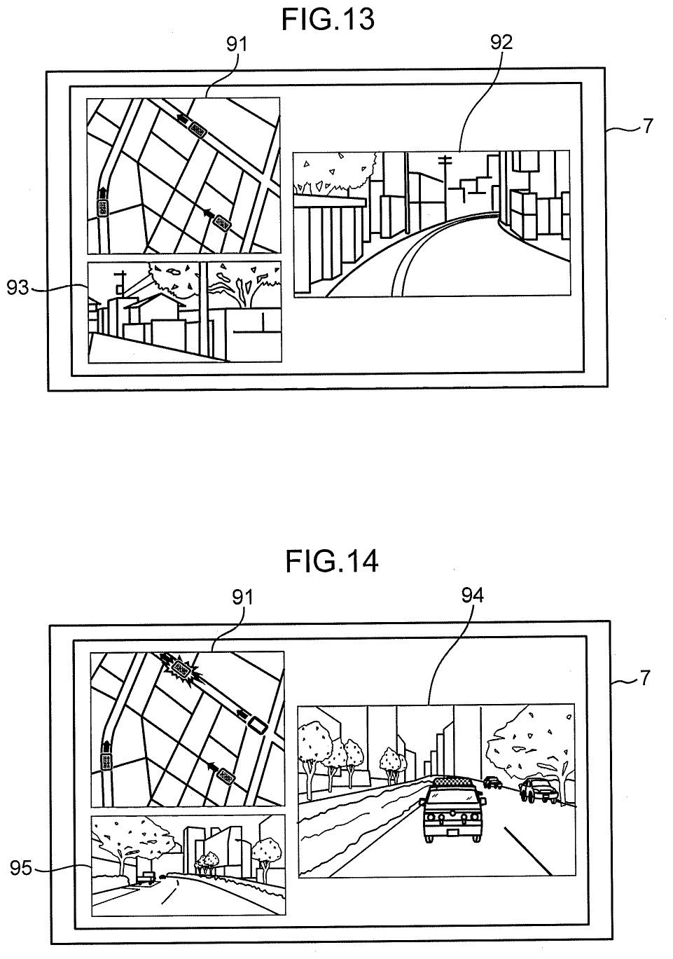

FIG. 13 is an illustration showing another exemplary display screens displayed on the display part 7 in the ordinary mode in which no emergency vehicle is approaching. FIG. 14 is an illustration showing another exemplary display screens displayed on the display part 7 in the emergency vehicle approach mode in which an emergency vehicle is approaching.

In the ordinary mode in FIG. 13, the display part 7 displays a map image 91 indicative of the positions of the vehicles on the map, a video 92 that captures an image in front of (in a moving direction of) a vehicle selected by the remote supervisor, and a video 93 that captures an image in front of (in a moving direction of) another vehicle not selected by the remote supervisor. The map image 91 shown in FIG. 13 is the same as the map image 81 shown in FIG. 11. An unillustrated input part may receive a selection by the remote supervisor of one of the videos taken by the vehicles. The video 92 selected by the remote supervisor is displayed in a size larger than a size of the video 93 not selected by the remote supervisor. In a case where a vehicle approached by an emergency vehicle is identified in pieces of sound data, the display screens change with an automatic transition from the ordinary mode in FIG. 13 to the emergency vehicle approach mode in FIG. 14.

In the emergency vehicle approach mode in FIG. 14, the display part 7 displays the map image 91, the video 94 that captures an image from the vehicle approached by the emergency vehicle in a direction in which the emergency vehicle is present and the video 95 that captures an image from the vehicle approached by the emergency vehicle in another direction different from the direction in which the emergency vehicle is present. Further, the speaker 8 indicates with a sound to the remote supervisor the vehicle approached by the emergency vehicle. The map image 91 shown in FIG. 14 is the same as the map image 81 shown in FIG. 12. The video 94 that captures the image from the vehicle approached by the emergency vehicle in the direction in which the emergency vehicle is present is displayed in a size larger than that of the video 95 that captures the image from the vehicle approached by the emergency vehicle in the another direction different from the direction in which the emergency vehicle is present. The remote supervisor consults the videos 94, 95 taken by the vehicle approached by the emergency vehicle and the map image 91. The speaker 8 may output sound data sent by the vehicle approached by the emergency vehicle.

In the ordinary mode, the video 92 selected by the remote supervisor is displayed in the largest size. In contrast, in the emergency vehicle approach mode, the video 94 that captures the image from the vehicle approached by the emergency vehicle in the direction in which the emergency vehicle is present is displayed in the largest size.

The emergency vehicle approach mode permits the remote supervisor to remotely control the vehicle approached by the emergency vehicle as needed so as to keep the vehicle from obstructing the passage of the emergency vehicle.

In this embodiment, the indication part 6 may indicate a vehicle within a predetermined range from the position of the emergency vehicle estimated by the estimation part 4 among the vehicles. The indication part 6 may calculate distances from the respective vehicles to the emergency vehicle on the basis of the pieces of positional information of the vehicles and the positional information of the emergency vehicle estimated by the estimation part 4, and indicate the vehicle whose calculated distance is a predetermined distance or smaller.

Further, in this embodiment, the identification part 5 may further include a moving speed estimation section that estimates a moving speed of the emergency vehicle on the basis of a time variation of the position of the emergency vehicle estimated by the estimation part 4. The moving speed estimation section may estimate a moving speed of the emergency vehicle on the basis of a previously estimated position of the emergency vehicle which is stored in the emergency vehicle position storage section 51 and the estimated position of the emergency vehicle, and a period from the previous estimation to the estimation. The indication part 6 may indicate the estimated moving speed of the emergency vehicle.

Further, in a case where, although the position of the emergency vehicle is estimated, the emergency vehicle is stationary, neither an estimation of a moving direction of the emergency vehicle nor an identification of a vehicle approached by the emergency vehicle can be carried out by the identification part 5. Accordingly, in a case where no vehicle approached by the emergency vehicle is identified although the position of the emergency vehicle is estimated, the identification part 5 may identify a vehicle within a predetermined range from the position of the emergency vehicle estimated by the estimation part 4 as the vehicle approached by the emergency vehicle.

Further, in this embodiment, the microphone 112 that acquires a piece of sound data indicative of a sound in surroundings of the first vehicle 11A is provided on the first vehicle 11A. However, the present disclosure is not particularly limited to this embodiment. For example, the microphone 112 may be provided on a road.

Further, the present disclosure is applicable not only to a remote monitoring device for remotely controlling a vehicle configured to travel autonomously but also to a server device that indicates to a vehicle having a communication function that the vehicle is being approached by an emergency vehicle. The server device may acquire a plurality of pieces of positional information indicative of respective positions from a plurality of vehicles having a communication function and acquire a plurality of pieces of sound data indicative of sounds in the respective surroundings of the vehicles. Further, in a case where a vehicle approached by an emergency vehicle is identified, the server device may indicate to the vehicle that the vehicle is being approached by the emergency vehicle.

Note that, in the above embodiments, each constituent element may be configured with dedicated hardware or may be obtained by executing a software program suitable for each constituent element. Each constituent element may be established by a program execution part, such as a CPU or a processor, reading and executing a software program recorded in recording medium, such as a hard disk or a semiconductor memory. Further, a program may be executed by another independent calculator system by recording the program on storage medium and transferring the program, or by transferring the program via a network.

Part or all of the functions of a device according to an embodiment of the present disclosure are established by a large-scale integration (LSI), which is typically an integrated circuit. These may be formed into chips individually, or may be formed into a single chip including a part or the whole. Further, the circuit integration is not limited to LSI, and may be achieved by a dedicated circuit or a general-purpose processor. A field programmable gate array (FPGA) that can be programmed after LSI fabrication, or a reconfigurable processor that can reconfigure connection and setting of circuit cells inside LSI may be used.

Further, part or all of the functions of a device according to an embodiment of the present disclosure may be established by a processor, such as a CPU, executing the program.

Further, all the numbers used above are illustrated to specifically describe the present disclosure, and the present disclosure is not limited to the illustrated numbers.

Further, the order in which the steps shown in the flowchart are performed is illustrated to specifically describe the present disclosure, and may be an order other than the above as long as similar effects can be obtained. Further, part of the above steps may be performed simultaneously (in parallel) with other steps.

Since the technique according to the present disclosure makes it possible to carry out a prompt and proper remote control of a vehicle approached by an emergency vehicle, the technique is useful as the technique of remotely monitoring a plurality of vehicles configured to travel autonomously and travel under remote control.

1. A remote monitoring device for remotely monitoring a plurality of vehicles configured to travel autonomously and travel under remote control, comprising:
an acquisition part that acquires a plurality of pieces of positional information indicative of respective positions of the vehicles and a plurality of pieces of sound data indicative of sounds in respective surroundings of the vehicles;
a detection part that performs detection of a siren sound of an emergency vehicle in each of the acquired pieces of sound data;
an estimation part that estimates, in a case where the siren sound is detected in pieces of sound data, a position of the emergency vehicle on the basis of the respective pieces of positional information of vehicles and the pieces of sound data;
an identification part that identifies a vehicle approached by the emergency vehicle among the vehicles on the basis of time variation of the estimated position of the emergency vehicle; and
an indication part that indicates the vehicle approached by the emergency vehicle in a case where the vehicle approached by the emergency vehicle is identified among the vehicles.

2. The remote monitoring device according to claim 1, further comprising:
a frequency domain transform part that transforms the pieces of sound data in a time domain into a plurality of pieces of sound data in a frequency domain, wherein
the detection part includes
a peak frequency detection section that detects a peak frequency in a frequency spectrum of each of the pieces of sound data in the frequency domain,
an emergency vehicle frequency pattern storage section that stores in advance a frequency pattern having a peak frequency of each of a plurality of siren sounds varying according to types of emergency vehicles, and
a determination section that compares respective frequency patterns having the detected peak frequencies with each of the frequency patterns stored in the emergency vehicle frequency pattern storage section and determines, in a case where a frequency pattern having a detected peak frequency matches one of the frequency patterns stored in the emergency vehicle frequency pattern storage section, that a piece of sound data having the detected peak frequency includes the siren sound.

3. The remote monitoring device according to claim 1, further comprising:
a frequency domain transform part that transforms the pieces of sound data in a time domain into a plurality of pieces of sound data in a frequency domain, wherein
the estimation part includes
a peak frequency level detection section that detects a level of a peak frequency in a frequency spectrum of each of the pieces of sound data in the frequency domain, and
a position estimation section that estimates the position of the emergency vehicle using the respective pieces of positional information of the vehicles, a result of the detection of the siren sound in each of the pieces of sound data, and the respective levels of the peak frequencies detected in the pieces of sound data.

4. The remote monitoring device according to claim 1, further comprising:
a frequency domain transform part that transforms the pieces of sound data in a time domain into a plurality of pieces of sound data in a frequency domain, wherein
the estimation part includes
a delay time calculation section that calculates a delay time between two different pieces of sound data pair by pair among the pieces of sound data in the frequency domain, and
a position estimation section that estimates the position of the emergency vehicle using the respective pieces of positional information of the vehicles, a result of the detection of the siren sound in each of the pieces of sound data, and the delay times calculated from the respective pairs.

5. The remote monitoring device according to claim 1, wherein
the identification part includes
an emergency vehicle position storage section that stores the estimated position of the emergency vehicle,
a moving direction estimation section that estimates a moving direction of the emergency vehicle on the basis of a previously estimated position of the emergency vehicle which is stored in the emergency vehicle position storage section and the estimated position of the emergency vehicle, and
a vehicle identification section that identifies the vehicle approached by the emergency vehicle on the basis of the estimated moving direction of the emergency vehicle and the respective pieces of positional information of the vehicles.

6. The remote monitoring device according to claim 1, wherein the indication part indicates a vehicle that is within a predetermined range from the estimated position of the emergency vehicle among the vehicles.

7. The remote monitoring device according to claim 1, wherein
the acquisition part further acquires video data taken by a camera included in each of the vehicles, and
the indication part outputs to a display part, in a case where the vehicle approached by the emergency vehicle is identified among the vehicles, the video data taken by the camera included in the vehicle approached by the emergency vehicle.

8. The remote monitoring device according to claim 1, wherein the indication part outputs to a display part, in a case where the vehicle approached by the emergency vehicle is identified among the vehicles, an indication image including a map, a plurality of first icons indicative of the respective positions of the vehicles on the map, and a second icon indicative of the estimated position of the emergency vehicle on the map.

9. The remote monitoring device according to claim 8, wherein the indication part displays a first icon indicative of the position of the vehicle approached by the emergency vehicle on the map in a state different from a state for another first icon indicative of the position of another vehicle not approached by the emergency vehicle on the map.

10. The remote monitoring device according to claim 1, wherein the indication part outputs to a speaker, in a case where the vehicle approached by the emergency vehicle is identified among the vehicles, an indication sound for indicating the vehicle approached by the emergency vehicle.

11. A remote monitoring method by a remote monitoring device for remotely monitoring a plurality of vehicles configured to travel autonomously and under remote control, comprising:
acquiring a plurality of pieces of positional information indicative of respective positions of the vehicles and a plurality of pieces of sound data indicative of sounds in respective surroundings of the vehicles;
performing detection of a siren sound of an emergency vehicle in each of the acquired pieces of sound data;
estimating, in a case where the siren sound is detected in pieces of sound data, a position of the emergency vehicle on the basis of the respective pieces of positional information of vehicles and the pieces of sound data;
identifying a vehicle approached by the emergency vehicle among the vehicles on the basis of time variation of the estimated position of the emergency vehicle; and
indicating the vehicle approached by the emergency vehicle in a case where the vehicle approached by the emergency vehicle is identified among the vehicles.

12. A non-transitory computer readable recording medium storing a remote monitoring program for remotely monitoring a plurality of vehicles configured to travel autonomously and travel under remote control, the remote monitoring program causing a computer to serve as:
an acquisition part that acquires a plurality of pieces of positional information indicative of respective positions of the vehicles and a plurality of pieces of sound data indicative of sounds in respective surroundings of the vehicles;
a detection part that performs detection of a siren sound of an emergency vehicle in each of the acquired pieces of sound data;
an estimation part that estimates, in a case where the siren sound is detected in pieces of sound data, a position of the emergency vehicle on the basis of the respective pieces of positional information of vehicles and the pieces of sound data;
an identification part that identifies a vehicle approached by the emergency vehicle among the vehicles on the basis of time variation of the estimated position of the emergency vehicle; and
an indication part that indicates the vehicle approached by the emergency vehicle in a case where the vehicle approached by the emergency vehicle is identified among the vehicles.

13. A remote monitoring system, comprising:
a plurality of vehicles configured to travel autonomously and travel under remote control; and
a remote monitoring device for remotely monitoring the vehicles, wherein
each of the vehicles includes:
a positional information acquisition part that acquires a piece of positional information indicative of a position of the vehicle;
a microphone that acquires a piece of sound data indicative of a sound in surroundings of the vehicle; and
a communication part that transmits the piece of positional information and the piece of sound data to the remote monitoring device, and
the remote monitoring device includes:
an acquisition part that acquires the pieces of positional information indicative of the respective positions of the vehicles and the pieces of sound data indicative of the sounds in the respective surroundings of the vehicles;
a detection part that performs detection of a siren sound of an emergency vehicle in each of the acquired pieces of sound data;
an estimation part that estimates, in a case where the siren sound is detected in pieces of sound data, a position of the emergency vehicle on the basis of the respective pieces of positional information of vehicles and the pieces of sound data;
an identification part that identifies a vehicle approached by the emergency vehicle among the vehicles on the basis of time variation of the estimated position of the emergency vehicle; and
an indication part that indicates the vehicle approached by the emergency vehicle in a case where the vehicle approached by the emergency vehicle is identified among the vehicles.

14. A device, comprising:
an acquisition part that acquires a plurality of pieces of positional information indicative of respective positions of a plurality of vehicles and a plurality of pieces of sound data indicative of sounds in respective surroundings of the vehicles;
a detection part that performs detection of a siren sound of an emergency vehicle in each of the acquired pieces of sound data;
an estimation part that estimates, in a case where the siren sound is detected in pieces of sound data, a position of the emergency vehicle on the basis of the respective pieces of positional information of vehicles and the pieces of sound data;
an identification part that identifies a vehicle approached by the emergency vehicle among the vehicles on the basis of time variation of the estimated position of the emergency vehicle; and
an indication part that indicates the vehicle approached by the emergency vehicle in a case where the vehicle approached by the emergency vehicle is identified among the vehicles.
